(19) United States
(12) Patent Application Publication
(10) Pub. No.: US 2010/0216082 A1
(43) Pub. Date: Aug. 26, 2010

(54) WORK STATION

(75) Inventors: Tsuyoshi MORIYA, Tokyo (JP); Yuki Hosaka, Nirasaki City (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Tokyo (JP)

(21) Appl. No.: 12/712,547

(22) Filed: Feb. 25, 2010

Related U.S. Application Data
(60) Provisional application No. 61/228,651, filed on Jul. 27, 2009.

(30) Foreign Application Priority Data
Feb. 26, 2009 (JP) 2009-043946

(51) Int. Cl. B23Q 41/00

(52) U.S. Cl. 432/92

(57) ABSTRACT

A work station is installed in a clean room for assembling or storing a component thereon. The work station includes a mounting member for mounting thereon the component, a heating device for heating to maintain an atmosphere surrounding the component mounted on the mounting member at a high temperature and a cover having an uneven structure for preventing a direct contact between the mounting member and the component by covering the mounting member. Further, at least a part of the uneven structure of the cover, the part being in contact with the component, is made of a material without containing a metal atom.

### CROSS-REFERENCE TO RELATED APPLICATIONS

This application claims priority to Japanese Patent Application No. 2009-043946 filed on Feb. 26, 2009, the entire contents of which are incorporated herein by reference.

### FIELD OF THE INVENTION

The present invention relates to a work station for use in a clean room.

### BACKGROUND OF THE INVENTION

Along with a trend for micro-fabrication of a semiconductor device, it is imperative to prevent particle adhesion to a wafer for the semiconductor device. As a technique for preventing the particle adhesion to the wafer, there is known a method for heating the wafer (see, e.g., Japanese Patent Application Publication No. 2003-115519).

Particles adhered to the wafer may be reaction products generated from a processing gas when a certain process, e.g., a plasma process, is performed on the wafer, or they may be broken pieces produced when components of a substrate processing apparatus make a contact with each other. Besides, particles already adhered to a component may be another source of the particles adhering to the wafer. To be specific, after the component is installed in the substrate processing apparatus, the particles adhered to the component may be peeled from the component to thereby float in the substrate processing apparatus. Then, the floating particles may reach the wafer to be finally adhered thereto.

In this regard, when maintenance of the substrate processing apparatus is performed, components are assembled on a work station installed in a clean room and the assembled components are stored thereon to prevent particle adhesion to the components. Usually, air is introduced into the clean room through a filter so that the number of particles floating in the clean room is small. Especially, the air is introduced into an operation area in the clean room through an ULPA filter and, thus, a degree of cleanness corresponding to Class 10 of Federal standard 209D can be achieved in the operation area.

However, even under the cleanness of Class 10, presence of 10000 particles/m³ having a diameter of about 100 nm is permitted. Thus, such degree of cleanness may not be sufficient in consideration of fabrication of a groove having a width of several tens of nanometers, which has recently begun to be primarily used.

Further, the degree of cleanness varies depending on locations even in the operation area. For example, the degree of cleanness in an area located directly under the ULPA filter is high, whereas that in an area around the work station which is located far away from the ULPA filter is low. Moreover, since an operator frequently moves the work station for the convenience of manipulation, particles present on a floor may be swirled up (floated) by the movement of the work station, resulting in deterioration of the degree of the cleanness around the work station. Besides, particles may be peeled off gloves or tools, which the operator uses, to thereby float in the apparatus. Thus, the degree of the cleanness around the work station is not so high even in the operation area. Accordingly, it may be difficult to prevent particle adhesion to the components assembled or stored on the work station.

### SUMMARY OF THE INVENTION

In view of the foregoing, the present invention provides a work station capable of preventing particle adhesion to a component assembled or stored thereon.

In accordance with a present invention, there is provided a work station installed in a clean room, for assembling or storing a component thereon, including: a mounting member for mounting thereon the component; a heating device for heating to maintain an atmosphere surrounding the component mounted on the mounting member at a high temperature; and an uneven structure covering the mounting member, for preventing a direct contact between the mounting member and the component, wherein at least a part of the uneven structure, the part being in contact with the component, is made of a material without containing a metal atom.

In this configuration, since at least the component is surrounded by the high-temperature atmosphere in the clean room, particles floating around the component are exerted by a thermophoretic force and are pushed away from the component. Accordingly, particle adhesion to the component assembled or stored on the work station can be prevented. Furthermore, the uneven structure is not only capable of preventing the direct contact between the mounting member and the component, but it is also capable of preventing metal contamination of the component because it is made of the material without containing any metal atom.

### BRIEF DESCRIPTION OF THE DRAWINGS

The objects and features of the present invention will become apparent from the following description of embodiments, given in conjunction with the accompanying drawings, in which:

FIG. 1 is a perspective view schematically illustrating a configuration of a work station in accordance with a first embodiment of the present invention;

FIGS. 2A to 2C illustrate a heater and a mounting plate cover of the work station shown in FIG. 1: FIG. 2A is a cross sectional view of the heater embedded in a mounting plate, FIG. 2B is an enlarged cross sectional view of a part A shown in FIG. 2A, and FIG. 2C is a plane view illustrating arrangement of grooves in the mounting plate cover;

FIG. 3 is a diagram for describing a thermophoretic force;

FIG. 4 provides a diagram for describing a cleaning method for the work station shown in FIG. 1;

FIG. 5 is a perspective view schematically illustrating a configuration of a modification example of the work station shown in FIG. 1;

FIGS. 6A and 6B are plane views illustrating arrangements of heaters embedded in mounting plates: FIG. 6A is a plane view illustrating an arrangement of a heater in the work station shown in FIG. 1 and FIG. 6B is a plane view illustrating an arrangement of a heater in a modification example of the work station shown in FIG. 1;

FIG. 7 is a side view schematically illustrating a configuration of a work station in accordance with a second embodiment of the present invention; and

FIG. 8 sets forth a cross sectional view schematically illustrating a modification example of the work station shown in FIG. 7.

### DETAILED DESCRIPTION OF THE EMBODIMENTS

Hereinafter, embodiments of the present invention will be described in detail with reference to the accompanying drawings which form a part hereof.

First, a work station in accordance with a first embodiment of the present invention will be explained.

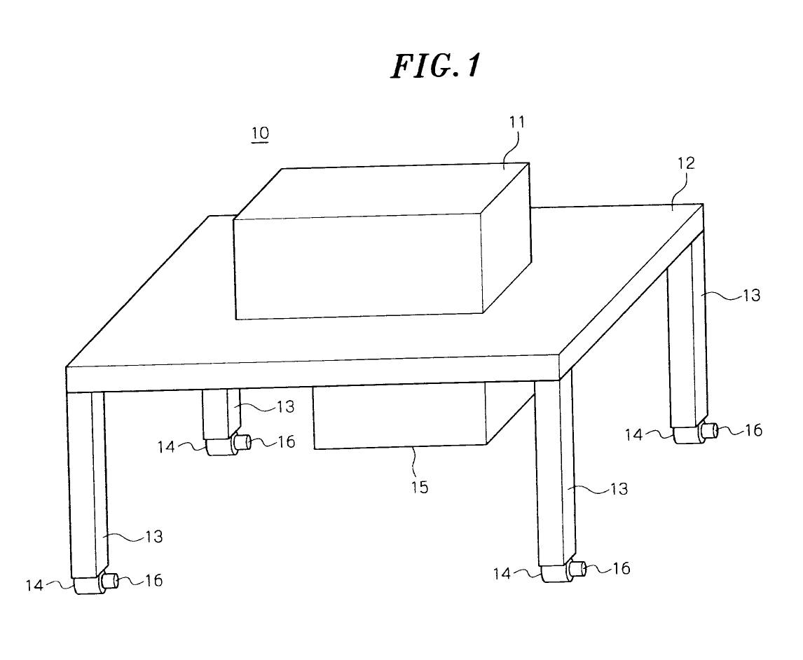

FIG. 1 is a perspective view illustrating a schematic configuration of a work station in accordance with the first embodiment. The work station 10 is used to assemble components of a substrate processing apparatus or the like or store the assembled components thereon within a clean room in which the number of particles is intentionally reduced by using an ULPA filter or the like.

In FIG. 1, the work station 10 includes a rectangular flat mounting plate 12 (mounting member) for mounting thereon a component 11 to be assembled or stored; four columnar legs 13 fixed at four corners of the mounting plate to support the mounting plate 12 while allowing the mounting plate 12 to be spaced apart from a floor surface of the clean room; casters (wheels) 14 installed at bottom end portions of the legs 13 by which the work station 10 can be moved; and a battery (electric power charge device) 15 provided on a bottom surface of the mounting plate 12; and generators 16 fastened to the respective casters 14.

Each caster 14 rotates in accordance with the movement of the work station 10, which allows each generator 16 to generate electric power. Further, the battery 15 is charged with the electric power thus generated from each generator 16.

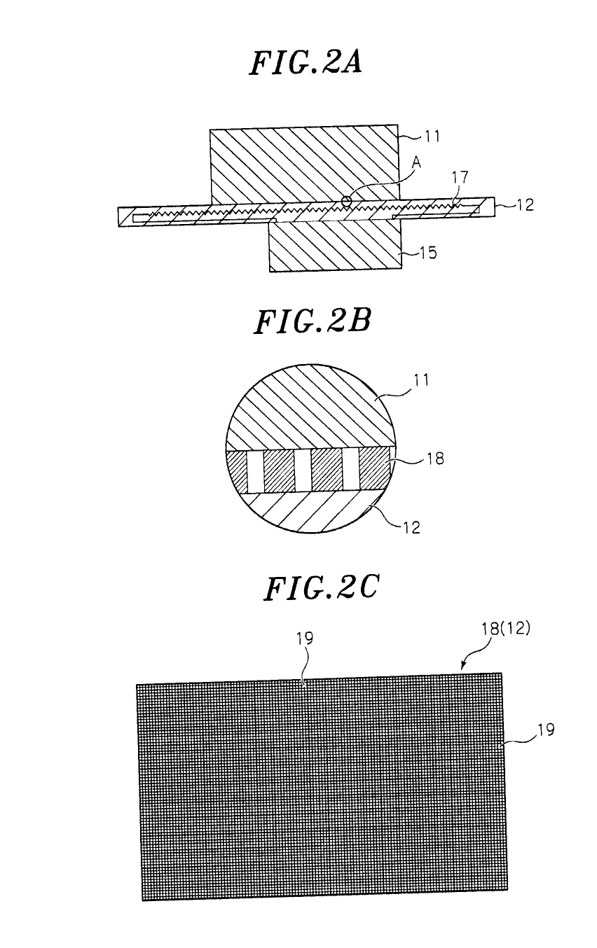

The work station 10 further includes a heater (heating device) 17; and a mounting plate cover 18 having uneven structure (concavity and convexity), for covering the mounting plate 12. The heater 17 is made of, e.g., a nichrome wire and is embedded in the mounting plate 12, as illustrated in FIG. 2A. Moreover, the battery 15 is connected with the heater 17, and the heater 17 generates heat by using the electric power supplied from the battery 15, whereby the component 11 mounted on the mounting plate 12 and an ambient atmosphere around the component are heated. As a result, the component 11 is surrounded by a high-temperature atmosphere whose temperature is higher than the atmosphere temperature in the clean room.

The mounting plate 12 is made of, e.g., stainless steel (SUS). Since, however, the mounting plate 12 is covered with the mounting plate cover 18, a direct contact between the SUS of the mounting plate 12 and the component 11 is avoided (see FIG. 2B). Further, the mounting plate cover 18 is made of a material without containing a metal atom, e.g., polytetrafluoroethylene. Accordingly, no metal (atom) comes into contact with the component 11.

The concavity and convexity of the mounting plate cover 18 is formed with grooves 19 arranged in a checkered lattice pattern (see FIG. 2C) when viewed from the top. Each groove 19 is opened outward at an edge portion of the mounting plate 12. That is, the inside of each groove 19 communicates with the inside of the clean room. Here, when a descending air current (downflow) is created in the clean room by a fan filter unit or the like, the descending air current flows toward the outside of the mounting plate 12 through the grooves 19 when it hits the mounting plate 12.

Further, each groove 19 is formed through the mounting plate cover 18 in its thickness direction. The mounting plate 12 is exposed to the component 11 or the ambient atmosphere around the component 11 through the grooves 19. Accordingly, heat released from the mounting plate 12 is transferred to the component 11 or the ambient atmosphere around the component 11 without being blocked by the mounting plate cover 18. Further, in case that the mounting plate cover 18 is made of a resin such as polytetrafluoroethylene, the mounting plate cover 18 can hold heat therein due to a heat storage effect of the resin. Thus, even after the electric power supply to the heater 17 is stopped, the component 11 or the ambient atmosphere around the component 11 is kept heated for a while by the heat stored in the mounting plate cover 18.

However, as stated earlier, there is a concern that particles may be adhered to the component 11 even in an operation area within the clean room, resulting in a defect of a semiconductor device produced from the wafer. Thus, in the present embodiment, particle adhesion to the component 11 is prevented by using a thermophoretic force.

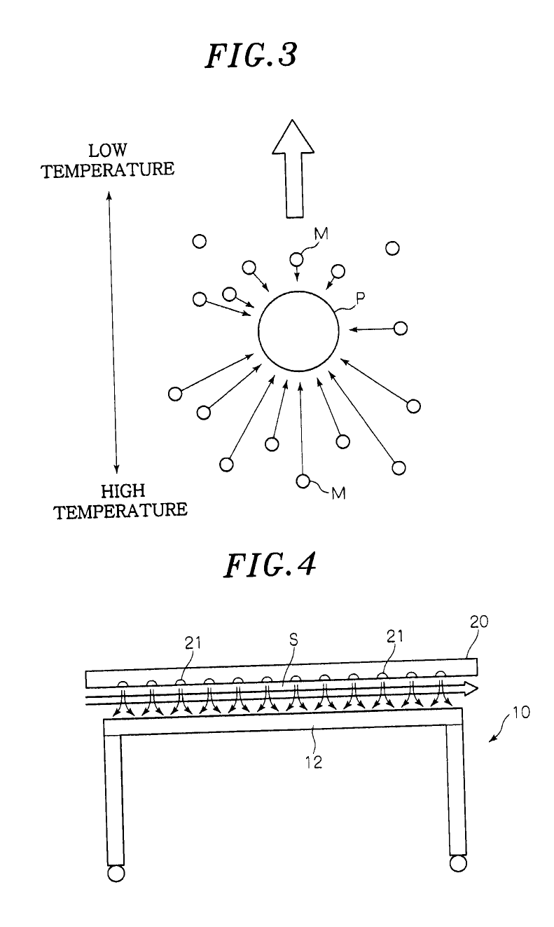

Here, the thermophoretic force will be explained with reference to FIG. 3. When there is a temperature gradient in a space where a particle P is located, gas molecules M in the high-temperature region of the particle P exhibit higher kinetic energies (indicated by thin black arrows in FIG. 3) than those of gas molecules M in the low-temperature region of the particle P. Accordingly, the particle P is subjected to a force (indicated by a thick white arrow in FIG. 3) that pushes it from the high-temperature region to the low-temperature region. The force exerted on the particle P in this way is called a thermophoretic force.

In the present embodiment, the component 11 is surrounded by the high-temperature atmosphere whose temperature is higher than the atmosphere temperature in the clean room, whereby a thermophoretic force is applied to particles floating around the component 11, thus making the particles move from the high-temperature region to the low-temperature region, i.e., move away from the component 11. Here, when a temperature difference between the high-temperature region and the low-temperature region is equal to or greater than about 5° C., the thermophoretic force is known to be surely applied to the particles. Especially, when the pressure of the atmosphere is in a range of about 1.3×10 Pa (100 mTorr) to 1.3 kPa (10 Torr), the force is found out to be more strongly exerted on the particle P. Thus, in the present embodiment, the component 11 or the ambient atmosphere around the component 11 is maintained at a temperature at least about 5° C. higher than a temperature of the atmosphere in the clean room by the heater 17, and a pressure in the clean room is regulated to be kept in the range of about 1.3×10 Pa (100 mTorr) to 1.3 kPa (10 Torr) by the fan filter unit or the like.

Further, if the component 11 is heated by the heater 17, a thermal stress is applied to particles already adhered to the component 11, so that the particles may be peeled off the component 11.

However, the particles moved away from the component 11 by the thermophoretic force or peeled off the component 11 by the thermal stress may fall down with the descending air current or due to gravity in the clean room and may be finally accumulated on a surface of the mounting plate cover 18, especially, in the grooves 19. Since the accumulated particles are highly likely to be adhered to the component 11 again, they need to be removed from the work station 10.

FIG. 4 is a diagram for describing a cleaning method for the work station shown in FIG. 1.

In FIG. 4, the work station 10 unloaded from the clean room is loaded into a cleaning apparatus (not shown) and is placed to face oppositely to a cleaning member 20 of the cleaning apparatus. The cleaning member 20 is made of a flat plate-shaped member and is provided with a number of steam ejection openings 21 in its surface facing to the mounting plate 12 of the work station 10. Further, the cleaning member 20 is arranged parallel to and spaced apart from the mounting plate 12 at a certain distance, whereby a flow path S is provided between the cleaning member 20 and the mounting plate 12.

If the cleaning member 20 ejects steam toward the mounting plate 12 (as indicated by thin black arrows in FIG. 4), the particles accumulated on the surface of the mounting plate cover 18 or in the grooves 19 are floated upward. At this time, if an air current is generated in the flow path S (indicated by a thick white arrow in FIG. 4) by an air blower (not shown) installed in the cleaning apparatus, the floating particles are moved out of the flow path S. As a result, the work station 10 is cleaned.

In the work station 10 in accordance with the present embodiment, the component 11 is surrounded by the high-temperature atmosphere in the clean room, and the temperature of the high-temperature atmosphere is maintained at least 5° C. higher than the atmosphere temperature in the clean room. Accordingly, the thermophoretic force is surely applied to particles floating around the component 11 so that the particles are pushed away from the component 11. Thus, particle adhesion to the component 11 assembled and stored on the work station 10 can be avoided.

Further, the mounting plate cover 18 is disposed to prevent a direct contact between the SUS of the mounting plate 12 and the component 11. Further, since the mounting plate cover 18 is made of a material, such as polytetrafluoroethylene, without containing any metal atom, metal contamination of the component 11 can be prevented, and the mounting plate cover 18 does not collapse even when the component 11 is heated. In this way, metal contamination of the component 11, which might be caused by a direct contact between the SUS of the mounting plate 12 and the component 11, can be suppressed successfully. Moreover, the mounting plate cover 18 may be made of a heat resistant material other than the polytetrafluoroethylene, or may be made of a heat resistant rubber or a hard rubber.

In the above-described work station 10, since the heater 17 is embedded in the mounting plate 12, the component 11 loaded on the mounting plate 12 and the ambient atmosphere around the component 11 can be heated effectively. Moreover, assembling, storing the component 11 or moving the work station 10 can be easily performed by an operator without being disturbed by the presence of the heater 17.

In addition, the work station 10 includes the generators 16 that generate the electric power by being driven by the rotation of the casters 14 when the work station 10 moves; and the battery 15 that is charged with the electric power generated by the generators 16, so that energy spent in the movement of the work station 10 can be recovered, whereby waste of energy can be avoided. Moreover, since there is no need to supply electric power by means of a cable or the like, the work station 10 can be moved easily.

In the above-described work station 10, the mounting plate cover 18 is provided with the grooves 19 opened outward at the edge portion of the mounting plate 12. Thus, when there has been generated a descending air current in the clean room, the descending air current flows through the respective grooves 19 toward the outside the work station 10 after hitting the mounting plate 12. As a result, particles accumulated in the grooves 19 without being adhered to the component 11 can be removed from the work station 10. Therefore, the work station 10 can be cleaned by the descending air current.

Further, in the above-described work station 10, since the mounting plate cover 18 has the uneven structure, a contact area between the mounting plate cover 18 and the component 11 is reduced. Thus, the possibility of reattachment of the particles accumulated on the surface of the mounting plate cover 18 to the component 11 can be reduced. Moreover, in the above-described exemplary work station 10, though the uneven structure is made up of rectangular solid protrusions surrounded with the grooves 19, it may be possible to implement the uneven structure with hemispherical protrusions. In such case, the contact area between the mounting plate cover 18 and the component 11 can be further reduced, whereby the possibility of the reattachment of the particles from the mounting plate cover 18 to the component 11 can be further reduced.

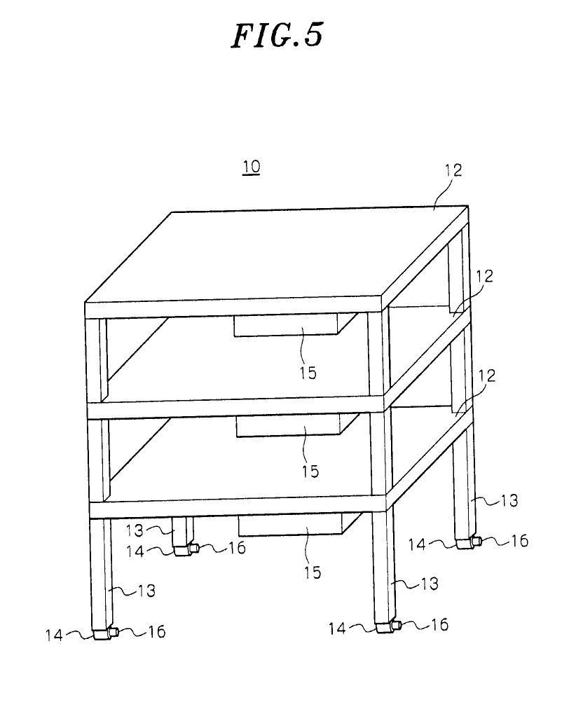

In the present embodiment, though the work station 10 includes only one mounting plate 12, it may include a plurality of mounting plates 12 so that the mounting plates provided with the four legs 13 are configured to be placed on top of one another, as illustrated in FIG. 5. With this configuration, multiple components 11 can be stored on top of one another in the same place at the same time, so that storage efficiency of the components 11 can be improved.

Moreover, in the above-described work station 10, though the heater 17 is embedded in the mounting plate 12, the heater 17 may not be buried in the mounting plate 12, but it may be installed in each groove 19. With this configuration, heating efficiency for the component 11 and the ambient atmosphere around the component 11 can be improved. Furthermore, a lamp heater installed above the mounting plate 12 may be used instead of the heater 17. In such a configuration, by irradiating heat rays from the lamp heater toward the component 11, only the component 11 and the ambient atmosphere around the component 11 can be heated efficiently.

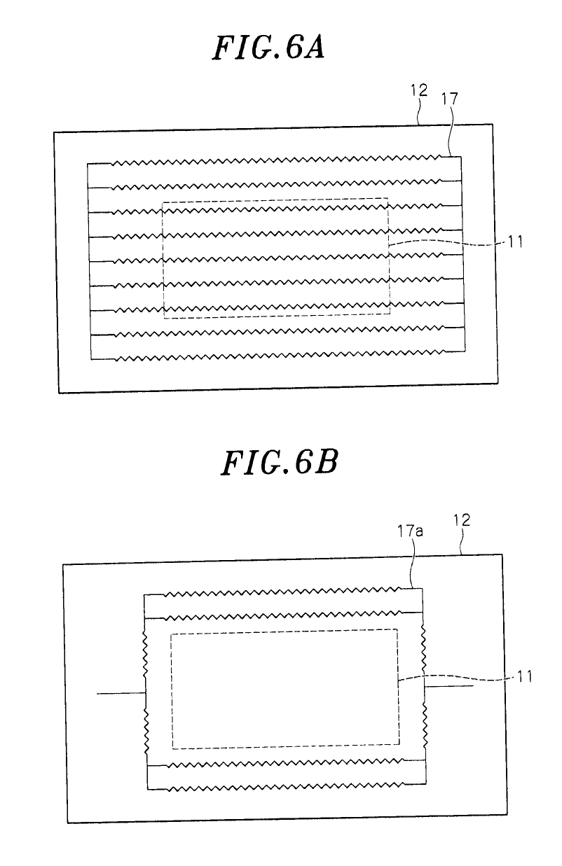

Furthermore, in the above-described work station 10, the heater 17 is buried in the entire surface of the mounting plate 12, as illustrated in FIG. 6A. However, since particle adhesion to the component 11 can be prevented as long as a thermophoretic force is applied to particles floating around the component 11, it may be possible to bury a heater 17a only in the vicinity of the component 11, as illustrated in FIG. 6B. With this configuration, electric power consumption of the heater 17 can be reduced.

Furthermore, though the generators 16 are used to generate the electric power, a solar cell provided at the mounting plate 12 may be used instead.

Now, a work station in accordance with a second embodiment of the present invention will be described.

The second embodiment is different from the first embodiment in that uses a descending air current generating device which generates a descending air current locally, though the basic configuration and operation of the second embodiment are the same as those of the first embodiment. Thus, redundant description will be omitted, while distinctive configuration and function will be focused and elaborated.

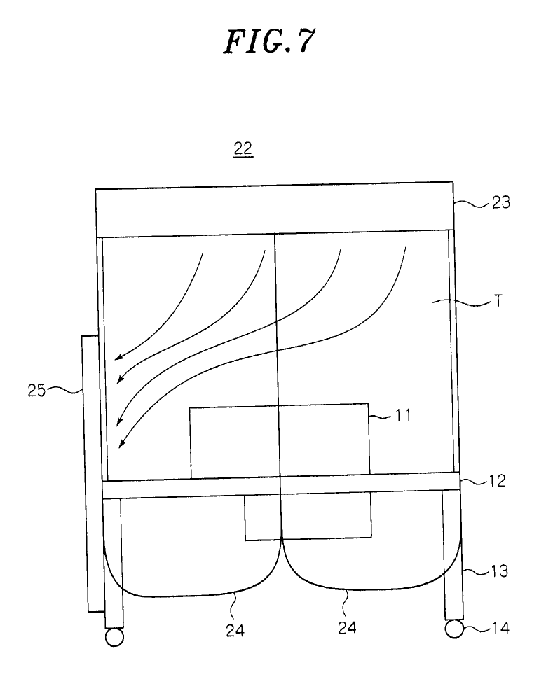

FIG. 7 is a side view schematically illustrating a work station 22 in accordance with the second embodiment of the present invention.

In FIG. 7, the work station 22 includes a local fan filter unit (air current generating device) 23 installed above a mounting plate 12 to oppositely face to the mounting plate 12; curtains 24 configured to isolate a local space T between the local fan filter unit 23 and the mounting plate 12 from the atmosphere within the clean room; a suction unit installed on the side of the mounting plate 12, for sucking an atmosphere in the local space T.

The local fan filter unit 23 creates a descending air current flowing down toward the mounting plate 12, and the suction unit 25 sucks the descending air current. Accordingly, an air current flowing downward, as indicated by arrows in FIG. 7, is generated in the local space T around the component 11. Particles that are moved away from the component 11 by a thermophoretic force generated from a high-temperature atmosphere surrounding the component 11 are carried by a viscous force of the air current and are removed from the local space T.

In the work station 22 in accordance with the second embodiment, since the air current flows around the component 11, the particles floating around the component 11 can be removed by the viscous force of the air current, whereby particle adhesion to the component 11 assembled or stored on the work station 22 can be surely prevented.

In the above-described work station 22, the descending air current generated by the local fan filter unit 23 is not being heated. However, it may be possible to set up a configuration in which the local fan filter unit 23 includes a heater (air current heating device) (not shown) to be used to generate a heated descending air current. In such case, a thermophoretic force as well as a viscous force can be applied to the particles floating around the component 11 by the heated air current generated around the component 11. That is, the thermophoretic force is applied to the particles floating around the component 11 from the heated air current as well as from the high-temperature atmosphere surrounding the component 11. Thus, the particles can be more effectively moved away to thereby be removed from the component 11.

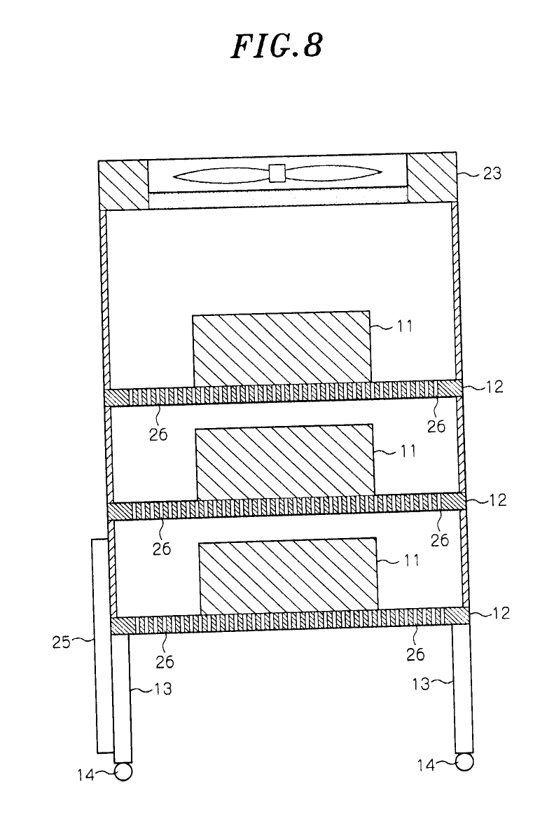

In the present embodiment, though the work station 22 includes only one mounting plate 12, it may include a plurality of mounting plates 12 so that the mounting plates provided with the four legs 13 are configured to be placed on top of one another, as illustrated in FIG. 8. With this configuration, storage efficiency of components 11 can be improved. In such case, each mounting plate 12 is desirably provided with punching holes 26 formed through the mounting plate 12 in thickness direction. With this configuration, the descending current generated by the local fan filter unit 23 is allowed to reach a lowermost mounting plate 12, so that particle adhesion even to a component 11 stored on the lowermost mounting plate 12 can be certainly prevented.

Moreover, in the above-described work station 22, though the local fan filter unit 23 and the work station 22 are configured as one unit, the local fan filter unit 23 may be installed separately from the work station. For example, when a component 11 is assembled and stored, the work station may be moved directly under the local fan filter unit, and a descending air current may be generated toward the component 11 loaded on the mounting plate 12. With this configuration, the size of the work station can be reduced, so that the work station can be moved readily.

While the invention has been shown and described with respect to the embodiments, it will be understood by those skilled in the art that various changes and modification may be made without departing from the scope of the invention as defined in the following claims.

What is claimed is:

1. A work station installed in a clean room, for assembling or storing a component thereon, comprising:
a mounting member for mounting thereon the component;
a heating device for heating to maintain an atmosphere surrounding the component mounted on the mounting member at a high temperature; and
a cover, which has an uneven structure, for preventing a direct contact between the mounting member and the component by covering the mounting member,
wherein at least a part of the uneven structure of the cover, the part being in contact with the component, is made of a material without containing a metal atom.

2. The work station of claim 1, wherein the heating device maintains the high-temperature atmosphere at a temperature at least about 5° C. higher than an atmosphere temperature in the clean room.

3. The work station of claim 1, wherein the heating device is a heater embedded in the mounting member.

4. The work station of claim 1, wherein the heating device is a lamp heater.

5. The work station of claim 1, wherein the material without containing the metal atom is polytetrafluoroethylene.

6. The work station of claim 1, further comprising:
a wheel that rotates when the work station moves;
a generator driven by the rotation of the wheel to generate an electric power; and
a power charge device for being charged by the electric power generated by the generator,
wherein the power charge device supplies the electric power to the heating device.

7. The work station of claim 1, wherein the uneven structure is provided with an outwardly opened groove.

8. The work station of claim 1, wherein one or more additional mounting members are provided and the mounting members are placed on top of one another.

9. The work station of claim 1, further comprising an air current generating device that generates an air current around the component.

10. The work station of claim 9, wherein the air current generating device includes an air current heating device for heating the air current.
